(19) United States
(12) Patent Application Publication
(10) Pub. No.: US 2016/0372014 A1
(43) Pub. Date: Dec. 22, 2016

(54) LUMINESCENT ROAD SIGN

(71) Applicants: Andrew Lee, Fort Lauderdale, FL (US); Zhi Qiang Liu, Shanghai (CN); Gang Li, Shanghai (CN)

(72) Inventors: Andrew Lee, Fort Lauderdale, FL (US); Zhi Qiang Liu, Shanghai (CN); Gang Li, Shanghai (CN)

(21) Appl. No.: 15/178,879

(22) Filed: Jun. 10, 2016

Related U.S. Application Data
(60) Provisional application No. 62/182,940, filed on Jun. 22, 2015.

(51) Int. Cl. G09F 13/20; B41F 15/00; C09D 5/22; C09D 7/12; G09F 13/16; E01F 9/00

(52) U.S. Cl. CPC G09F 13/20; G09F 13/16; E01F 9/00; C09D 5/22; C09D 7/1216; B41F 15/00

(57) ABSTRACT

Road signs having a front face with directional indicia or other informational indicia thereon are provided with a photoluminescent composition containing rare earth materials. The photoluminescent composition is applied to at least a portion of the area of the front face of the road signs. In a preferred embodiment, the composition containing the rare earth materials is applied by silk screening. A clear coat composition is applied over the previously applied photoluminescent composition to discourage wearing and fading of the rare earth material. In at least one preferred embodiment, the front face of the road signs includes a reflective material that meets Federal Department of Transportation specification requirements, and the rare earth material composition is silk screened on the surface of the reflective material.

### BACKGROUND OF THE INVENTION

This non-provisional patent application is based on provisional patent application serial no. 62/182,940 filed on Jun. 22, 2015.

Field of the Invention

The present invention relates to road signs and, more particularly, to road signs or traffic signs that include one or more rare earth materials applied thereto in order to provide luminescent qualities in dark or near dark conditions.

Discussion of the Related Art

Road signs or traffic signs are used extensively along the sides of roads, or above roads, to provide instructions or other information to motorists. Road signs include, but are not limited to, regulatory signs (e.g., stop signs, speed limit signs), warning signs (e.g., approaching curve in the road, animal crossing signs) and guide signs (e.g., street name signs, route marker signs, expressway signs). In the United States, signs that are placed along roads that are regulated by the U.S. Department of Transportation must meet certain specifications, including the requirement of certain reflection specifications. This allows the sign to be viewed when the headlights of an automobile shine in a direction towards the sign. Notwithstanding, most signs are not easily visible at night, especially when there are no streetlights along the road. This is particularly true in rural areas where there are no streetlights or other lights in the area (e.g., from buildings, parking lots, etc.). In many instances, signs along roads in rural areas do not need to comply with U.S. Department of Transportation regulations. And, even if they do have reflective material, as required by Federal Department of Transportation regulations, the signs are only visible if a vehicle's headlights are bright and shined directly at the sign.

Accordingly, there remains a definite need for road signs that are provided with a luminescent material that allows for easy visibility in dark and dim light conditions. Moreover, there remains a need for luminescent road signs that will emit light for an extended period of time of at least three hours in dark and/or dim light conditions.

### SUMMARY OF THE INVENTION

The present invention is directed to luminescent road signs that emit a glowing light during dark and dim light conditions. In particular, a photoluminescent material containing one or more rare earth materials is applied to the front faces of road signs, by silk screening. A clear coat composition is then applied over the previously silk screened rare earth photoluminescent material to prevent wearing and fading. The photoluminescent composition of the present invention, containing one or more rare earth materials, can be applied to reflective material that is used on existing road signs by silk screening the photoluminescent composition directly to the reflective material surface.

In a preferred embodiment, the photoluminescent material composition of the present invention is applied around a perimeter border of the front face of the sign to enhance visibility of the road sign. The photoluminescent material composition may further be applied to letters, symbols and/or images on the sign to enhance their visibility in dark and dim light conditions. The rare earth materials contained within the photoluminescent composition are adapted to be quickly charged with light energy from the sun, ambient light and headlights from passing vehicles. Moreover, the rare earth materials are adapted to emit a luminescent glowing light for an extended period of time of at least three hours.

The rare earth elements and composite materials used in the photoluminescent composition of the present invention include, but are not limited to, photoluminescent materials such as aluminate photoluminescent pigment, silicate photoluminescent pigment and nitrides photoluminescent pigment.

### BRIEF DESCRIPTION OF THE DRAWINGS

For a fuller understanding of the nature of the present invention, reference should be made to the following detailed description taken in conjunction with the accompanying drawings in which:

FIG. 1 is a front elevational view of a speed limit road sign in accordance with the present invention as seen during daylight conditions; and

FIG. 2 is a front elevational view of the speed limit road sign of FIG. 1 as seen in dark conditions, such as nighttime, in accordance with the present invention.

Like reference numerals refer to like parts throughout the several views of the drawings.

### DETAILED DESCRIPTION OF THE PREFERRED EMBODIMENT

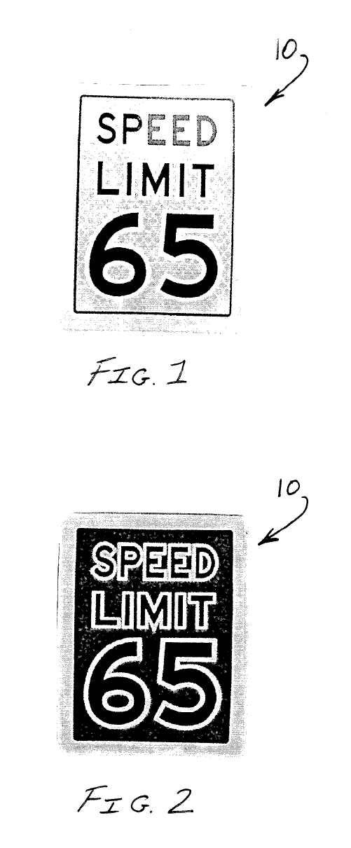

The present invention is directed to luminescent road signs that emit light during dark and dim light conditions. An example of the luminescent road signs of the present invention is shown in FIGS. 1 and 2 and is generally indicated as 10. The luminescent road sign example shown in FIGS. 1 and 2 is a speed limit sign much like those typically seen on roads and highways throughout the United States. The luminescent road signs of the present invention include at least a portion of the front face of the sign having a photoluminescent composition applied thereto. In the examples shown in FIGS. 1 and 2, the letters in the words “SPEED LIMIT” are outlined with a photoluminescent composition. Additionally, the digits in the number “65” are outlined with the photoluminescent composition. Finally, in the example shown in FIGS. 1 and 2, the border of the speed limit sign is outlined with the luminescent composition. In accordance with the present invention, the photoluminescent composition contains one or more rare earth materials. The photoluminescent composition is applied to the front face of road signs during manufacturing and in accordance with a specific method of application.

An example of the method of the present invention used for manufacturing luminescent road signs includes the following steps:

1. Providing a photoluminescent composition comprising a mixture of materials including one or more rare earth materials.

2. Providing a sheet of High Intensity Prismatic (HIP) reflective film that is approved by the United States Department of Transportation for use in the manufacture of road and traffic signs, such as HIP reflective film manufactured by the 3M company of Maplewood, Minn.

3. Applying a white color base paint to the top exposed surface of the HIP reflective film.

4. Applying a first layer of 30-50 mu of the mixed photoluminescent composition to the white painted surface of the HIP reflective film at specific desired areas (e.g., around the boarder and outlining letters, numbers and symbols) with the use of a semi-automatic silk screen machine.

5. Allowing the applied first layer to air dry for approximately 48 hours.

6. Applying a second layer of 70-85 mu of the mixed photoluminescent composition to the top surface, on top of the first layer of the previously applied photoluminescent composition.

7. Allowing the applied second layer to air dry for approximately 36 hours.

8. Applying a third layer of 30-50 mu of pure rare earth material powder with transparent adhesive applied over the previously applied first and second layers of the mixed photoluminescent composition to fill any gaps or spaces remaining after application of the first and second layers.

9. Placing the HIP reflective film with the applied first, second and third layers in a sealed ultraviolet light tunnel at a temperature of between 275 and 325 degrees Celsius, and preferably at approximately 300 degrees Celsius, to allow the applied layers to seal tightly to the HIP reflective film and distribute the photoluminescent composition evenly on the applied surface.

10. Repeat the steps of applying the first layer and the second layer of the mixed photoluminescent composition (i.e., repeat steps 4 through 7, as set forth above).

11. Placing the HIP reflective film with the applied layers through a high pressure machine to compact the applied layers.

12. Applying a final top coat of a clear transparent sealer to secure the applied layers of photoluminescent composition to the HIP reflective film and to discourage separation of the applied layers from the HIP reflective film.

What is claimed is:

1. A luminescent road sign comprising:
a sheet of high intensity prismatic reflective film having a front face with letters, numbers and/or symbols appearing thereon; and
a photoluminescent material composition applied to at least a portion of the front face of the sheet of high intensity prismatic reflective film and the photoluminescent material composition including at least one rare earth material.

2. The luminescent road sign of claim 1 wherein the photoluminescent material composition is applied over at least a portion of the letters, numbers and/or symbols on the front face of the sheet of high intensity prismatic reflective film.

3. The luminescent road sign of claim 1 wherein the photoluminescent material composition is applied to outline at least a portion of the letters, numbers and/or symbols on the front face of the sheet of high intensity prismatic reflective film.

4. The luminescent road sign of claim 1 wherein the photoluminescent material composition is applied to a peripheral border on the front face of the sheet of high intensity prismatic reflective film.

5. A method of manufacturing a luminescent road sign comprising the steps of:
providing a photoluminescent composition comprising a mixture of materials including one or more rare earth materials;
providing a sheet of high intensity prismatic reflective film;
applying a white color base paint to at least one area of a top exposed surface of the sheet of reflective film comprising at least a portion of a total area of the top exposed surface of the sheet of reflective film;
applying a first layer of 30-50 mu of the photoluminescent composition to the white painted area on the top surface;
allowing the applied first layer to air dry;
applying a second layer of 70-85 mu of the photoluminescent composition to the white painted area on the top surface of the sheet of reflective film, on top of the first layer of the previously applied photoluminescent composition;
allowing the applied second layer to air dry;
applying a third layer of 30-50 mu of pure rare earth material powder with transparent adhesive over the previously applied first and second layers of the photoluminescent composition to fill any gaps or spaces remaining after application of the first and second layers;
placing the sheet of reflective film with the applied first, second and third layers in a sealed ultraviolet light tunnel at a temperature of between 275 to 325 degrees Celsius to allow the applied first, second and third layers to seal tightly to the white painted are on the top surface of the sheet of reflective film and distribute the photoluminescent composition evenly on the applied area of the white painted area on the top surface;
repeating the steps of applying the first layer and the second layer of the photoluminescent composition;
placing the sheet of reflective film with the applied layers through a high pressure machine to compact the applied layers; and
applying a final top coat of a clear transparent sealer over the top surface and the applied layers to secure the applied layers of photoluminescent composition to the sheet of reflective film and to discourage separation of the applied layers from the sheet of reflective film.
